(19) United States
(12) Patent Application Publication
(10) Pub. No.: US 2020/0269075 A1
(43) Pub. Date: Aug. 27, 2020

(54) Tower Positioner

(71) Applicant: Thompson Tree Tools LLC, Ithaca, NY (US)

(72) Inventor: Morgan Thompson, Ithaca, NY (US)

(21) Appl. No.: 16/795,534

(22) Filed: Feb. 19, 2020

Related U.S. Application Data
(60) Provisional application No. 62/809,228, filed on Feb. 22, 2019.

(51) Int. Cl. A62B 1/14; A63B 29/02; A62B 35/00

(52) U.S. Cl. CPC A62B 1/14; A62B 35/0081; A63B 29/024

(57) ABSTRACT

A climbing tool for work positioning on a rope, usable as an ascender, speed control descender, lanyard rope grab and fall arrest device. The tool is for use with a single rope, a doubled rope or in a two line configuration.

### REFERENCE TO RELATED APPLICATIONS

This application claims one or more inventions which were disclosed in Provisional Application No. 62/809,228, filed Feb. 22, 2019, entitled “TOWER POSITIONER”. The benefit under 35 USC § 119(e) of the United States provisional application is hereby claimed, and the aforementioned application is hereby incorporated herein by reference.

### BACKGROUND OF THE INVENTION

### Field of the Invention

The invention pertains to the field of climbing tools. More particularly, the invention pertains to tools for climbing, descending and work positioning on ropes.

### Description of Related Art

In the conventional angled hole design, (like in U.S. Pat. No. 5,279,020 “Rope Clutch”) the top pressure point or friction interface does the majority of the friction generation due to a steep incidence angle of engagement, and the second pressure point does very little because the sides of the hole make the ropes incidence angle to the pressure point shallow.

Fall arrest devices, such as the one in U.S. Pat. No. 7,137,481, that lock on the rope and need to be unloaded to be released, often times requiring a rescue operation to bring the climber safely to the ground.

### SUMMARY OF THE INVENTION

The tower positioner is a climbing tool for work positioning on a rope, usable as an ascender, speed control descender, lanyard rope grab and fall arrest device. The tool is for use with a single rope, a doubled rope or in a two line configuration. The new design is an improvement because the geometry generates increased friction per plate, requiring fewer plates for a given friction requirement.

As an ascender, the tower positioner can be advanced up a rope freely with little resistance, but when a downward weight is applied, the device grips the rope and prevents any movement downward along the rope. The more weight applied, the harder the device grips the rope, up to a calibrated weight holding capacity at which point the device slips. This slip is helpful when the device is subjected to a shock load, like in a fall arrest situation. The peek force of the fall is absorbed or dissipated by the device slipping on the rope. The device decelerates the load until the load is under the weight holding capacity of the device at which point the load is arrested by the device. This is a safety feature and limits the damaging forces exerted on the climbers body, the rope, and the device. After a fall arrest occurs, the device can be safely released to descend the rope, which is unique to this device.

As a speed control descender, the tower positioner's grip on the rope can be released in a progressive way, by incrementally depressing the control handle, to the point where the device begins to slip on the rope, with descent speed being controlled by the extent the control handle of the device is depressed or released.

### BRIEF DESCRIPTION OF THE DRAWING

FIG. 1 shows a perspective view of the device in the open position, in use in a single-rope technique, in an embodiment where the device has a unitary body.

FIG. 2 shows a perspective view of the device in the open position, in use in a single-rope technique, with the rope led upward over the roller.

FIG. 3 shows a side view of the device in the engaged position, in use in a single-rope technique.

FIG. 4 shows a side view of the device in the engaged position, in an embodiment in which the device is made up of links, and the plates are formed with alternating openings to insert the tool midline on the rope, with a roller under the lower plate.

FIG. 5a shows a diagram of the path of the rope through a control plate in the open position.

FIG. 5b shows a diagram of the path of the rope through a control plate in the engaged positions.

FIG. 6 shows a perspective view of the device in the engaged position, in an embodiment where the device is made up of links, without a roller under the lower plate.

FIG. 7 shows a side view of the device in the engaged position, in an embodiment where the device is made up of links, without a roller under the lower plate.

FIG. 8 shows a perspective view of the device in the open position, in an embodiment where the device is made up of links, without a roller under the lower plate.

FIG. 9 shows a perspective view from a first side of another embodiment of the device, in which the device is made up of links, and the plates are formed with alternating openings to insert the tool midline on the rope.

FIG. 10 shows a perspective view from a second, opposite side of another embodiment of the device, in which the device is made up of links, and the plates are formed with alternating openings to insert the tool midline on the rope.

FIG. 11 shows a perspective view of the embodiment of the device of FIGS. 9 and 10, with a rope through the plates.

FIG. 12 shows a perspective view of the embodiment of the device of FIGS. 9 and 10, in the engaged position and the rope guided upward.

FIG. 13 shows the embodiment of the device of FIGS. 1-3, with the rope passed over an anchor point and attached to the top attach point.

FIG. 14 shows a side cut-through view of a top (control plate with a rope passing through the plate.

FIG. 15 shows a side cut-through view of a top control plate.

FIG. 16 shows a perspective cut-through view of a top control plate.

FIG. 17 shows a perspective view of a control plate as used in the embodiment of FIGS. 1-3.

FIG. 18 shows a cut-through perspective drawing of a bottom attach plate as used in the embodiment of FIG. 4.

FIG. 19 shows a perspective view of an alternate link body embodiment of the device.

FIG. 20 shows a perspective view of a shroud for fall arrest for use with a tower positioner.

FIG. 21 shows a perspective view of the shroud coupled to a tower positioner.

FIG. 22 shows a perspective view of the shroud and tower positioner with a rope wrapped around the shroud.

FIG. 23 shows a perspective side cut away view of the shroud and tower positioner with the rope wrapped around the shroud.

FIG. 24 shows another perspective side cut away view of the shroud and tower positioner with the rope wrapped around the shroud.

FIG. 25 shows a perspective view of a tower positioner of another embodiment including magnets in a closed position.

FIG. 26 shows a perspective view of a tower positioner of another embodiment including the magnets in the open position.

FIG. 27 shows a perspective view of a tower positioner with extra plates for additional grip.

FIG. 28 shows a perspective view of a tower positioner with a swivel at each end of the tower positioner.

FIG. 29 shows a perspective view of spring biased plate.

FIG. 30 shows side view of a tower positioner in which top and bottom attachment points are perpendicular to the axis of the plates.

### DETAILED DESCRIPTION OF THE INVENTION

The tower positioner is a climbing tool for work positioning on a rope, usable as an ascender, speed control descender, lanyard rope grab and fall arrest device. The tool is for use with a single rope, a doubled rope or in a two line configuration.

### Rope Control Plates

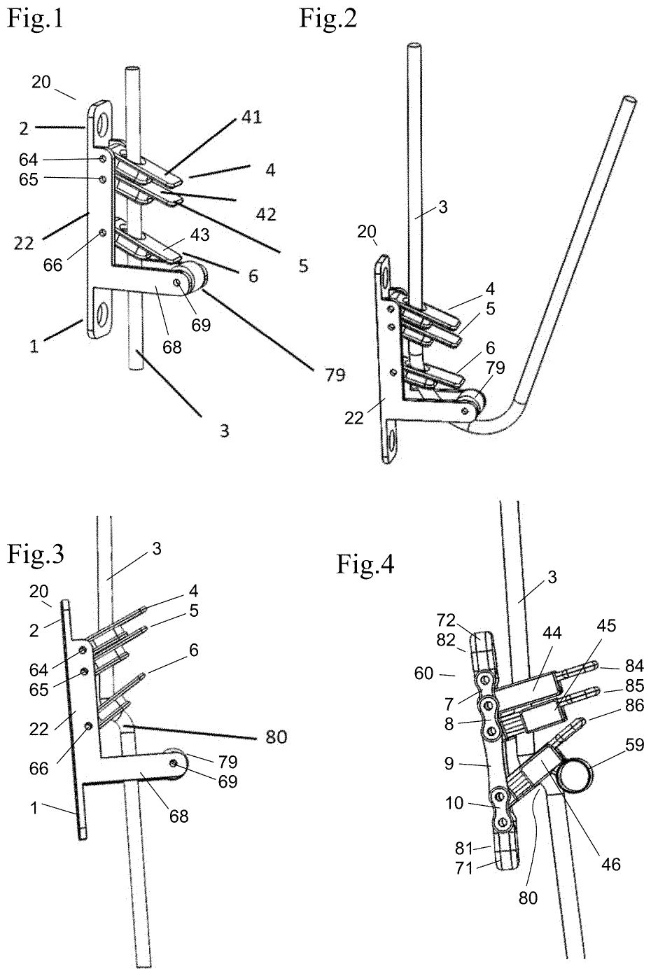

### FIGS. 1, 5a-5b, 14-17

Referring to FIG. 1, the tower positioner (in this figure in the unitary-body embodiment 20) is comprised of three rope control plates—upper control plate 4, middle control plate 5 and lower control plate 6—pivotally connected to a unitary body 22. Each plate is preferably approximately the same thickness as the diameter of the rope 3 to be used.

Each of the plates 4, 5, 6 have two offset oblong holes, an upper hole 11 (see FIGS. 15-17 showing plate 4) in the top side and a lower hole 12 on the bottom, separated by a space or gap 13 between them (in the center of the plate). The offset between the holes 11, 12 along the long axis of the oblong is preferably approximately one half the diameter of the rope 3.

One end of the plate 4, 5, 6 has a through-hole 52 for an axle, and the opposite end has an extended handle 41, 42, 43 respectively, for a user to cause the plate 4, 5, 6 to pivot on the axle. The axle hole 52 is drilled through the plate 4, 5, 6 along the axis of the short side of the oblong profile, and at a distance of 2-3 rope diameters from the center of the rope channel 98.

As shown in FIGS. 14-15 and 17, the offset between the upper hole 11 and lower hole 12 perpendicular to the axis of the axle hole 52 of the plate 4, creating a rope path 19 through the plate 4 that is at an angle 14 of approximately 30 degrees relative to a straight path 18 through the plate 4. The holes 11, 12 have oblong profiles, approximately the width of the diameter of the rope 3, and are approximately 1¼ the diameter of the rope 3 long. Preferably, all the edges of holes 11, 12 are formed with a rounded edge or fillet 15 to create a smooth channel for the rope 3 to pass through in one position, and be clamped against in another position. The fillet 15 preferably has a radius of approximately ⅙ of the thickness of the rope 3.

As can be seen in FIG. 5a, the offset holes 11, 12 are positioned so that when handle 41 of the plate 4 is at a downward angle, the rope path 99 from upper hole 11 to lower hole 12 is open, and the rope 3 can freely pass through the holes 11, 12 with no resistance or effort. As can be seen in FIG. 5b, when the handle 41 of the plate 4 is pivoted in an upward angle, the offset holes 11, 12 create a S shaped path and require the rope 3 to bend 80. This creates progressively more resistance as the plate's upward angle increases, which generates friction between the rope 3 and bottom pressure point 50 and top pressure point 51, to hold the weight of the climber.

The amount of pull needed to draw the rope 3 through the plate in the fully engaged position shown in FIG. 5b is dictated by the offset of the two holes 11, 12, the radius of the fillets 15 of the holes, the thickness of the plates 4, 5, 6, the thickness of the pressure points 50, 51, as well as the distance of the holes 11, 12 from the axle 52 on which the plates 4-6 pivot. These variables can be changed to get the desired weight holding capacity of the plate.

The upper control plate 4 and middle control plate 5 interact and generate friction with each other as a plane clamp. The upper control plate 4 and the middle control plate 5 pivot relative to each other and shift in a planar way when a load is applied, offsetting the holes relative to each other, causing a pinching or lenticular shrinking of the rope channel 98 that the rope 3 is traveling through. This adds friction in a pinching or clamping fashion. Alone, this is very effective at stopping the rope 3, but release is abrupt, and hard to control.

By adding the lower control plate 6, which acts as a “brake”, release is considerably more gradual, and easy to control. The lower control plate 6 allows the rope 3 to pass freely through the plate 6 in the open position shown in FIG. 5a, and puts a tight bend 80 in the rope 3 in the engaged position shown in FIG. 5b. Applying a bend force imparts friction to hold a value of weight before the rope 3 begins to slide through the plate 6.

When holding the climber's weight on the rope 3, the plates 4, 5, 6 share the load. When the upper control plate and middle control plates 4, 5 are incrementally forced toward the open position by pushing down on the top handle 41, which in turn pushes down on the middle control plate 5, the pinching effect and the bending effect of the upper control plate 4 and middle control plate 5 is progressively reduced until, for any given weight, the point of slipping on the rope 3 can be found. At this point upper and middle control plates 4, 5 have released most of their grip, and the lower control plate or “brake” plate 6 is holding most of the load. At this point, the upper control plate 4 and middle control plate 5 come into contact with the lower control plate 6 and start to push it down toward the open position. This reduces the grip of lower control plate 6 and increases the speed of descent down the rope 3. The speed of descent can be controlled by adjusting the extent of the angle of the plates 4-6. This makes release more progressive, and makes modulating the degree of friction easier over a larger range of adjustment.

### Unitary-Body Embodiment

### FIGS. 1-3, 13

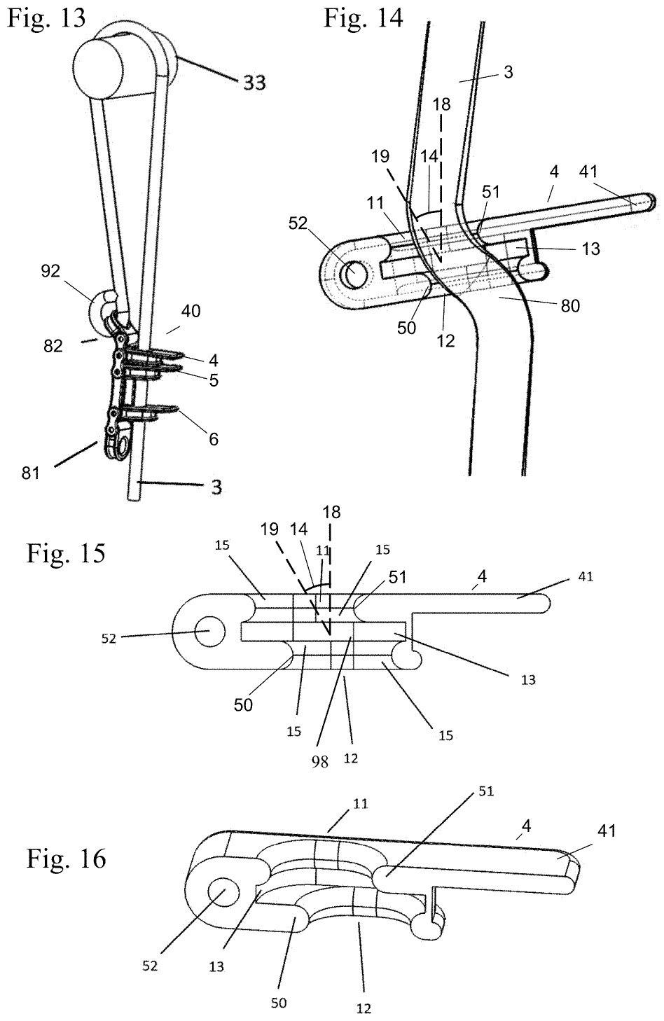

In this embodiment, the unitary tower positioner device 20 has a unitary body 22 in the form of a C-shaped channel with axle holes 64, 65, 66 to accept axles passing through holes 52 in the plates 4, 5, 6, respectively. At the top and bottom of the body 22 are attachment holes 1, 2 to accept a connector such as a carabineer or the like, for attachment to a climbing harness or as shown in FIG. 13, to provide a place for the rope 3 to be tied in a knot 92.

Optionally, the unitary body 22 can be provided with a fairlead roller 79 mounted by an axle 69 on a roller arm 68 to facilitate advancing the unitary tower positioner device 20 up the rope 3. This can be seen in FIG. 2, where the tail of the rope 3 is exiting the bottom of the unitary tower positioner device 20, and then is pulled upward against the roller 79 as a fairlead.

FIG. 3 shows the rope 3 through the plates 4-6 in the fully engaged position with the plates 4-6 pivoted in an upward angle, such that the offset holes 11, 12 of the plates 4-6 create a S shaped path and require the rope 3 to bend 80.

### Link-Body Embodiment

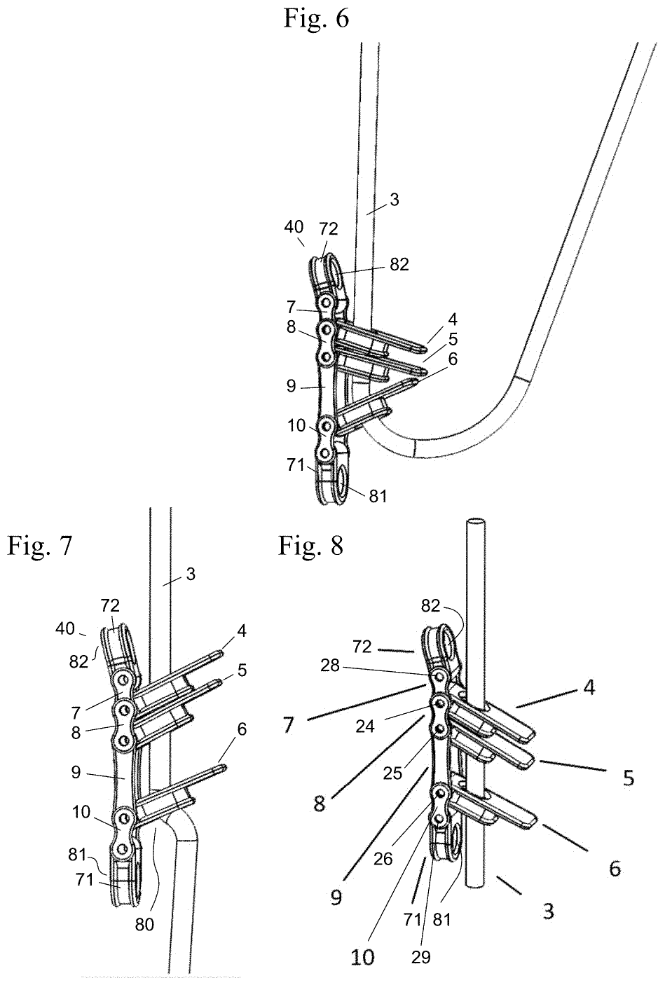

### FIGS. 6-8

As shown in FIGS. 6-8, instead of using a unitary body 22 as in the embodiment above, the tower positioner device 40 can have a bendable body which is formed by a series of links. In order from top to bottom, these links are a top attach link 72 with the top attach point 82, a first link 7, a second link 8, a third link 9, a fourth link 10 and a bottom attach link 71 with the bottom attach point 81. The links 72, 7, 8, 9, 10, 71 are connected by axles or pins 24-26 so that adjoining links can bend or pivot relative to each other.

The axle or pin 24 connecting the first link 7 and the second link 8 forms the axle for the upper control plate 4, the axle or pin 25 which connects the second link 8 and the third link 9 forms the axle for the middle control plate 5, and the axle or pin 26 connecting the third link 9 and the fourth link 10 forms the axle for the lower control plate 6. Top attachment link 72 is connected to the first link 7 through axle or pin 28. Bottom attachment link 71 is connected to the fourth link 19 through axle or pin 29.

FIG. 6 shows the tail of the rope 3 exiting the bottom of the device 40, and then is pulled upward as a fairlead. FIG. 7 shows this embodiment of the tower positioner device 40 in the engaged position, while FIG. 8 shows the tower positioner device 40 in the open position. FIG. 18 shows cross-sectional view of the upper control plate 4.

### Open-Hole Embodiment

### FIGS. 4 and 9-12

In the embodiments described above, the holes 11, 12 through the control plates 4, 5, 6 are formed as closed oblong openings. As a result, the devices 20, 40 described above require that an end of the rope 3 be threaded through the holes 11, 12 in the control plates 4-6. In this embodiment, shown in FIGS. 4 and 9-12, no threading is required and the rope 3 can be inserted into the device 60 midline on the rope 3.

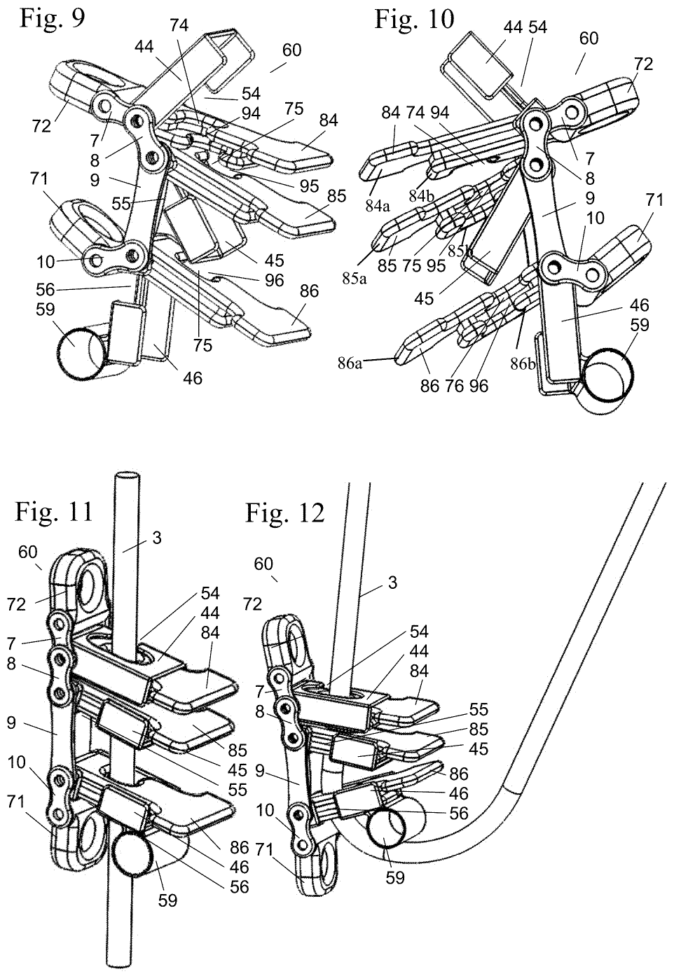

As can be seen in FIGS. 9 and 10, the upper control plate 84, middle control plate 85 and lower control plate 86 are formed with side openings 94, 95, 96 which allow side access into the rope passages 74, 75, 76. The upper control plate 84 has a first top sub plate 84a and a second top sub plate 84b with the first top sub plate 84a having a side opening of an upper hole 11 on a first side and the second top sub plate 84b having an opening of a lower hole 12 on the same side but offset forming the offset rope passage 74. The middle control plate 85 has a first top sub plate 85a and a second top sub plate 85b with the first top sub plate 85a having a side opening of an upper hole 11 on a first side and the second top sub plate 85b having an opening of an lower hole 12 on the same side but offset forming the offset rope passage 75. The side openings of the middle control plate are on an opposite side of the side openings of the upper control plate 84 and the lower control plate 86. The lower control plate 86 has a first top sub plate 86a and a second top sub plate 86b with the first top sub plate 86a having a side opening of the upper hole 11 on a first side and the second top sub plate 86b having an opening of the lower hole 12 on the same side but offset forming the offset rope passage 76. The side openings of the lower control plate 86 are on the same side as the openings of the upper control plate 84.

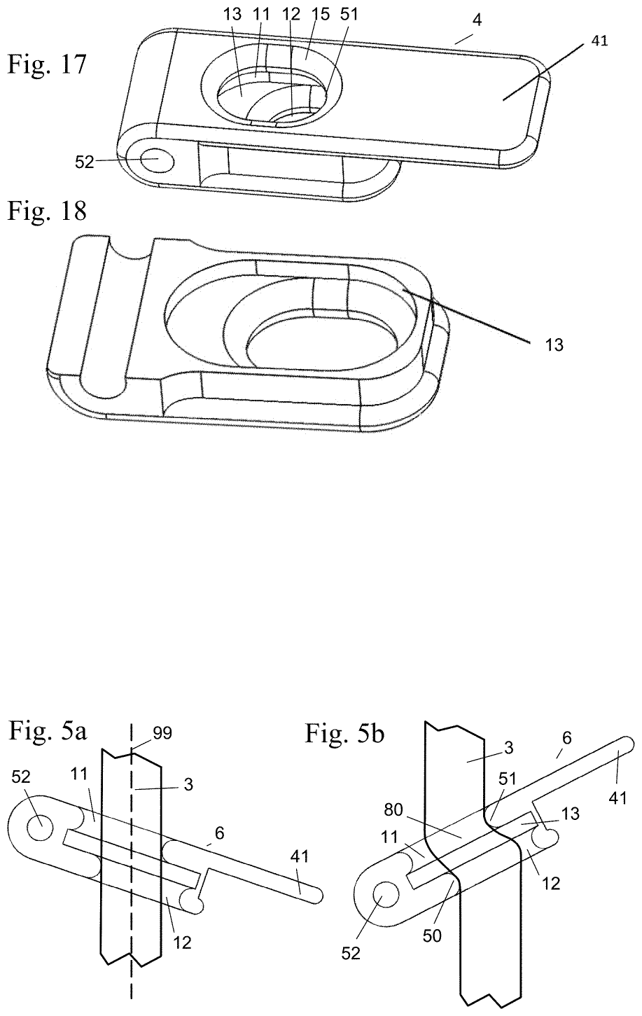

The rope passages 74, 75, 76 are formed of offset upper and lower holes 11, 12 as described above in reference to FIGS. 15-16, and will not be further described in this section.

The side openings 94, 95, 96 can all be aligned on one side of the plates 84, 85, 86, or they can alternate from side to side, or as shown in the figures, the side opening 94 on the upper control plate 84 can be on one side, and side openings 95, 96 on the middle control plate 85 and lower control plate 86 can be on the opposite side. However the side openings 94-96 are arranged, the rope 3 can be easily threaded through the side openings 94-96 into the rope passages 74-76.

This embodiment can be provided with lock plates 44-46 covering over each control plates 84-86, as shown in the figures. Each of the lock plates 44-46 has oblong holes with a side openings 54-56 on the opposite side from the side openings 94-96 on the control plates 84-86 which it covers. By pivoting the lock plates 44-46 down over its associated control plates 84-86, the rope 3 can be secured in the rope passages 74-76 and prevented from slipping back out the side openings 94-96.

In this embodiment, a roller or curved guide 59 can be provided on the lock plate 46 covering the lower control plate 86, which functions in the same way as the roller 79 in the unitary-body embodiment above.

It will be understood that while FIGS. 4, 9-12 show the body of the tower positioner device 60 as being formed from links, as in the embodiment described in detail immediately above, this embodiment could also be used with a unitary-body embodiment as first described.

### Alternate Link Body Embodiment

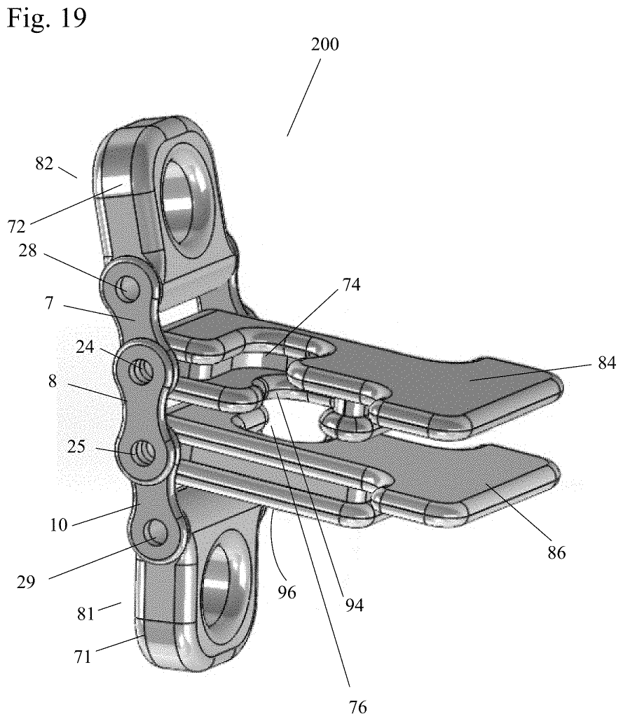

### FIGS. 18-19

The tower positioner device 200 has a bendable body which is formed by a series of links. In order from top to bottom, these links are a top attach link 72 with the top attach point 82, a first link 7, a second link 8 and a fourth link 10 and a bottom attach link 71 with the bottom attach point 81. The third rigid link 9 as previously described is not present in this embodiment. The links 72, 7, 8, 10, 71 are connected by axels or pins so that adjoining links can bend or pivot relative to each other. The rope 3 can be inserted into the tower positioner device 200 midline on the rope 3 similar to FIG. 11 due to the alternating rope passages 74, 76.

The axle or pin 24 connecting the first link 7 and the second link 8 forms the axle for the upper control plate 84, the axle or pin 25 which connects the second link 8 and the fourth link 10 forms the axle for the lower control plate 86. Axle or pin 28 connects the first link 7 to the top attachment link 72. Axle or pin 29 connects the fourth link 10 to the bottom attachment link 71.

The upper control plate 84 and lower control plate 86 are formed with side openings 94, 96 which allow side access into the rope passages 74, 76. The rope passages 74, 76 are formed of offset upper and lower holes 11, 12 as described above, and will not be further described in this section.

The side openings 94, 96 can all be aligned on one side of the plates 84, 86, or they can alternate from side to side as shown in the figure, the side opening 94 on the upper control plate 84 can be on one side, and side opening 96 on the lower control plate 86 can be on the opposite side. However the side openings 94, 96 are arranged, the rope 3 can be easily threaded through the side openings 94, 96 into the rope passages 74, 76.

It should be noted that while the second link 8 is shown outwardly adjacent the first link 7 and the fourth link 10 in the figures, alternatively, the first link 7 and the fourth link 10 could be outwardly adjacent the second link 8.

### Shroud Embodiment

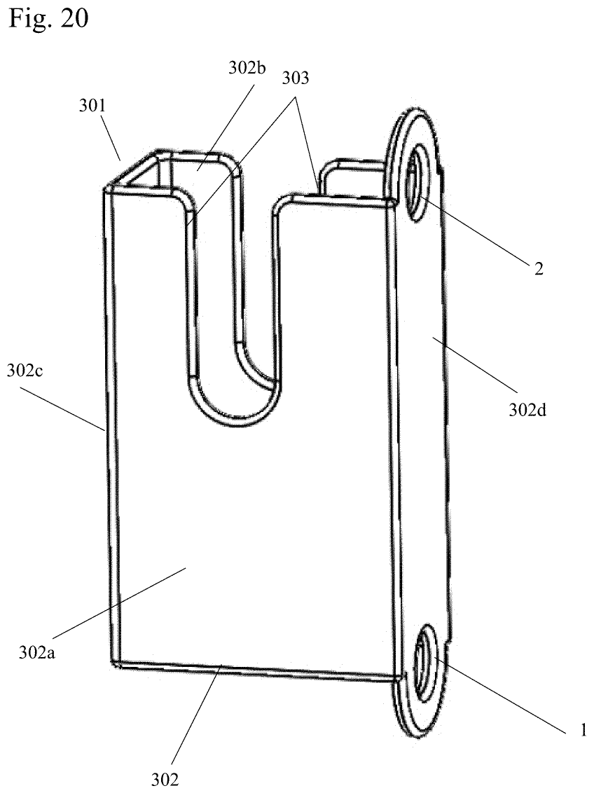

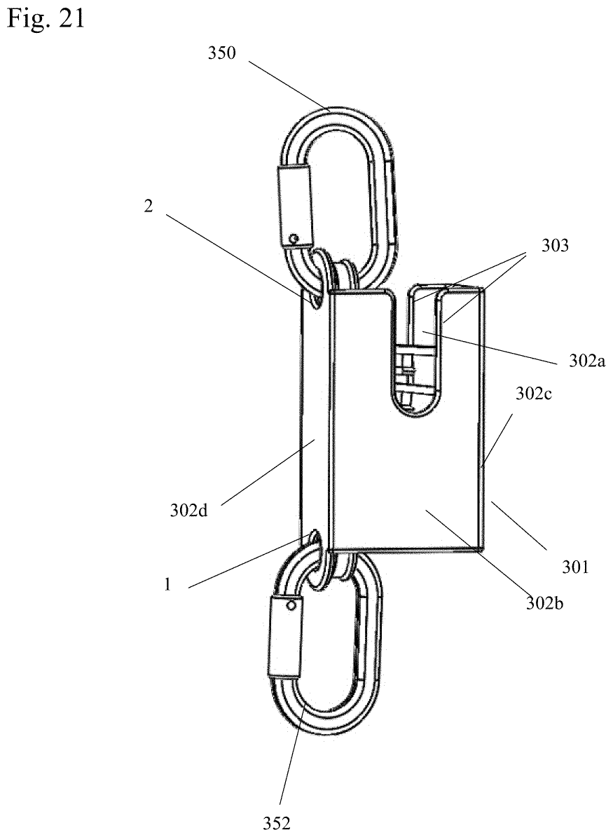

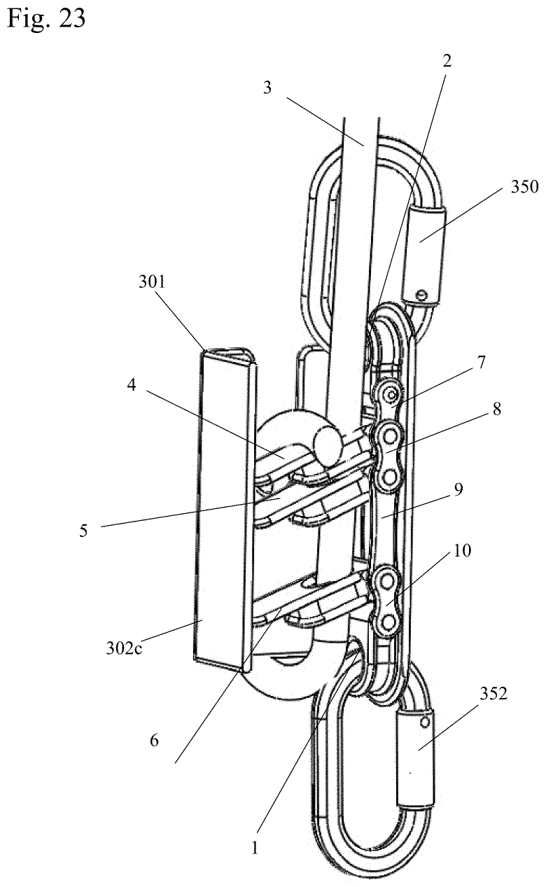

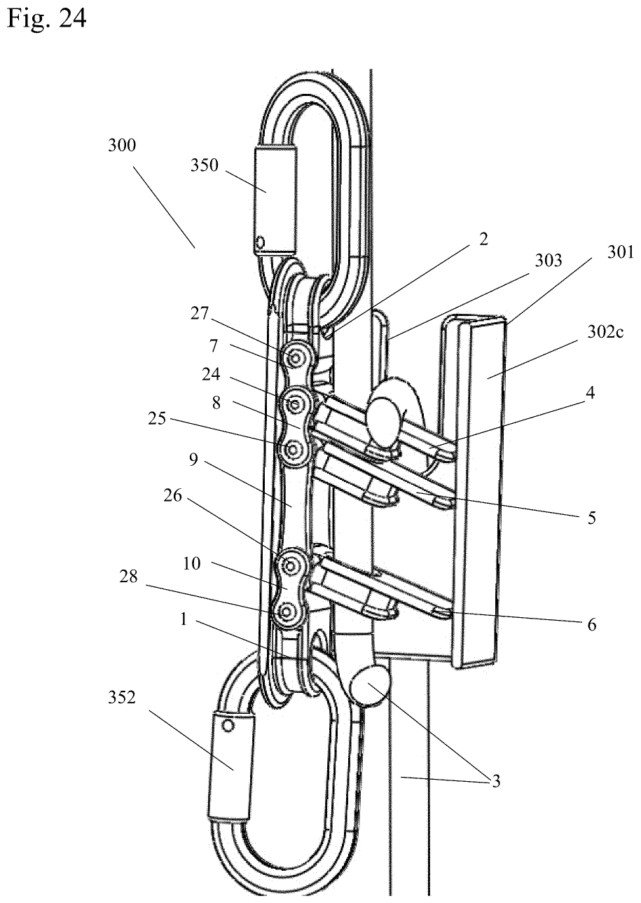

### FIGS. 20-24

A removable shroud 301 can cover the tower positioner device 300 during use of the tower positioner device 300 as a fall arrest device. The removable shroud 301 prevents the handles of the plates 4-6 of the tower positioner 300 from inadvertently being depressed by the climber's body or failing debris.

Referring to FIGS. 20-24, the shroud 301 has a body 302 with a first side 302a, a second side 302b, a front side 302c and a back side 302d. The back side 302d has a first attachment hole 2, and a second attachment hole 1 and is adjacent the tower positioner 300 during use. On the first side 302a and the second side 302b is a U-shaped slot 303. The first attachment hole 2 and the second attachment hole 1 can receive carabineers 350, 352. It should be noted that the shroud 301 is hollow and does not have a top or bottom, allowing the rope 3 to slide in and out of the interior of the shroud 301 defined by the body 302 and then wrapped into place by wrapping the rope 3 such that it is received within the U-shaped slot 303.

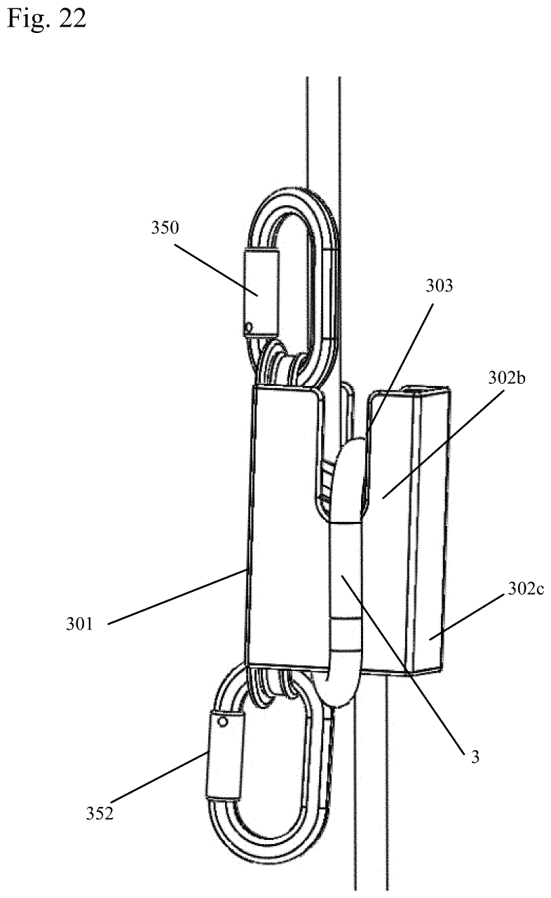

FIGS. 22-24 show the tower positioner device 300 within the shroud 301.

The tower positioner device 300 has a bendable body which is formed by a series of links. In order from top to bottom, these links are a top attach link 72 with the top attach point 82, a first link 7, a second link 8, a rigid third link 9, a fourth link 10 and a bottom attach link 71 with the bottom attach point 81. The links 72, 7, 8, 9, 10, 71 are connected by axels or pins so that adjoining links can bend or pivot relative to each other. The top attachment point 82 of the top attach link is aligned with the first attachment hole 2 of the shroud 301. The bottom attachment point 81 of the bottom attach link 71 is aligned with the second attachment hole 1 of the shroud 301. As shown, a single carabineer 350 passes through both the top attachment point 82 and the first attachment hole 2, and another single carabineer 350 passes through both the bottom attachment point 81 and the second attachment hole 1, linking the shroud 301 to the tower positioner 300.

The axle or pin 24 connecting the first link 7 and the second link 8 forms the axle for the upper control plate 4, the axle or pin 25 which connects the second link 8 and the third link 9 forms the axle for the middle control plate 5, and the axle or pin 26 connecting the third link 9 and the fourth link 10 forms the axle for the lower control plate 6. Axle or pin 27 connects the first link 7 to the top attach link 82. Axle or pin 28 connects the fourth link 10 to the bottom attach link 71.

Rope 3 is received within the holes of the plates 4-6 for ascending. To descend, the rope 3 is wrapped back around and received within the U-shaped slot 303 of the shroud 301 and contacts the handle 41 of the top control plate 4, such that the rope 3 pulls down on the plates 4-6 forcing the plates 4-6 to the closed position.

While the shroud is shown using control plates 4-6, control plates 84-86 may also be used.

### Magnet Embodiment

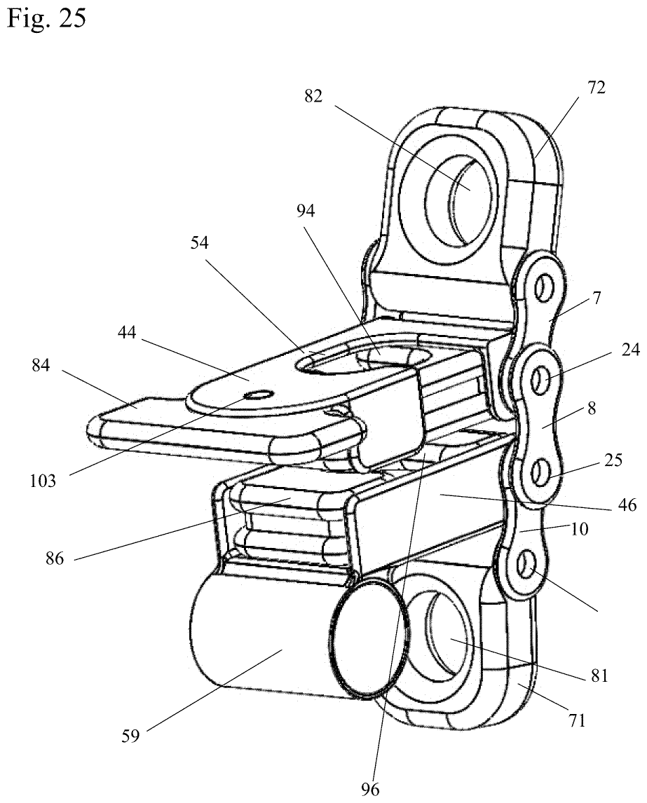

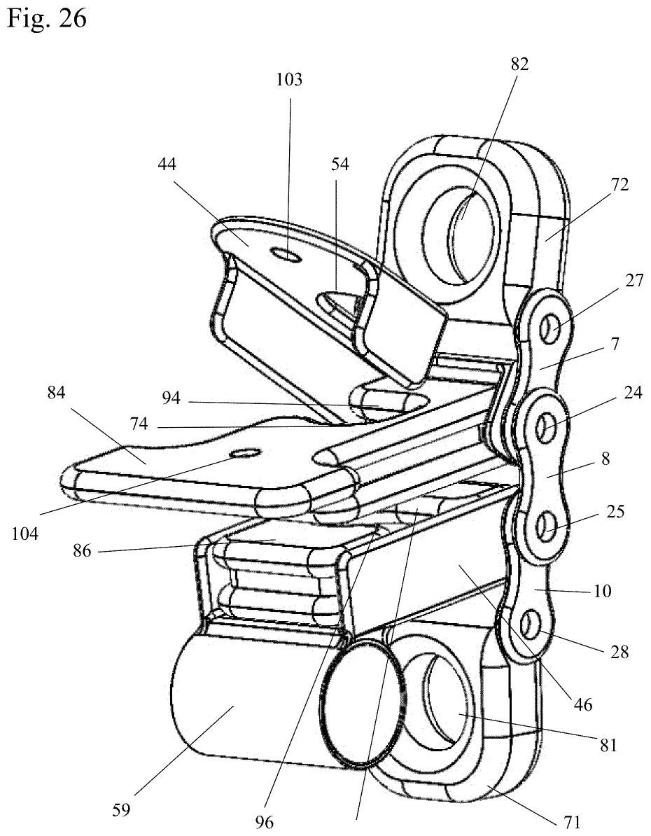

### FIGS. 25-26

The tower positioner device 400 has a bendable body which is formed by a series of links. In order from top to bottom, these links are a top attach link 72 with the top attach point 82, a first link 7, a second link 8 and a fourth link 10 and a bottom attach link 71 with the bottom attach point 81. The rigid third link 9 as previously described is not present in this embodiment. The links 72, 7, 8, 10, 71 are connected by axels or pins so that adjoining links can bend or pivot relative to each other. The rope 3 can be inserted into the tower positioner device 400 midline on the rope 3 similar to the depiction in FIG. 11 due to the alternating rope side openings 94, 96.

The axle or pin 24 connecting the first link 7 and the second link 8 forms the axle for the upper control plate 84, the axle or pin 25 which connects the second link 8 and the fourth link 10 forms the axle for the lower control plate 86.

The upper control plate 84 and lower control plate 86 are formed with side openings 94, 96 which allow side access into the rope passages 74, 76. The rope passages 74, 76 are formed of offset upper and lower holes 11, 12 as described above, and will not be further described in this section.

The side openings 94, 96 can all be aligned on one side of the plates 84, 86, or they can alternate from side to side as shown in the figure, the side opening 94 on the upper control plate 84 can be on one side, and side opening 96 on the lower control plate 86 can be on the opposite side. However the side openings 94, 96 are arranged, the rope 3 can be easily threaded through the side openings 94, 96 into the rope passages 74, 76.

Lock plates 44, 46 cover over each control plate 84, 86, as shown in the figures. In this embodiment, the lock plates 44-46 preferably includes a magnet 103 that is attracted to a magnet 104 present in the upper control plate 84 and in the lower control plate 86. The magnets 103-104 ensure that the lock plates 44-46 remains over and adjacent the upper and lower control plates 84, 86. Lock plate 44 has oblong holes with a side opening 54 on the opposite side from the side opening 94 on the control plate 84 which it covers. By pivoting the lock plate 44 down over its associated control plate 84, the rope 3 can be secured in the rope passage 74 and prevented from slipping back out the side opening 94. Lock plate 46 covers the lower control plate 86 and includes a roller or curved guide 59, which functions in the same way as the roller 79 in the unitary-body embodiment above.

### Extra Clutch Embodiment

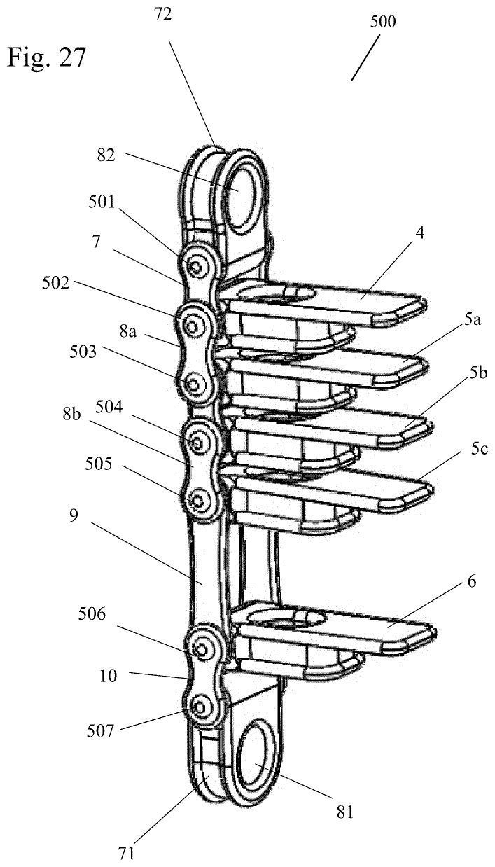

### FIG. 27

The tower position device 500 has a bendable body which is formed by a series of links. In order from top to bottom, these links are a top attach link 72 with the top attach point 82, a first link 7, a plurality of second links 8a, 8b, a third link 9, a fourth link 10 and a bottom attach link 71 with the bottom attach point 81. The links 72, 7, 8a, 8b, 9, 10, 71 are connected by axles or pins 501, 502, 503, 504, 505, 506, 507 so that adjoining links can bend or pivot relative to each other.

The axle or pin 501 connects the first link 7 to the top attach link 72. The axle or pin 502 connects the first link 7 and a second link 8a and forms the axle for the upper control plate 4. Axle or pin 503 connects the second link 8a to a first middle control plate 5a. Axle or pin 504 connects the other second link 8b to a second middle control plate 5b. Axle or pin 505 connects the other second link 8b to a third middle control plate 5c. Axle or pin 506 forms the axle connecting the other second link 8b to the third rigid link 9. Axle or pin 506 connects the third link 9 and the fourth link 10 to the lower control plate 6 and axle or pin 507 connects the bottom attach link 71 to the fourth link 10. The additional middle control plates 5a, 5b, 5c provide extra grip and clutch on the rope 3.

While the additional middle control plates were shown being attached to a bendable body, the additional middle control plates could be added to a unitary body as well.

### Swivel Embodiment

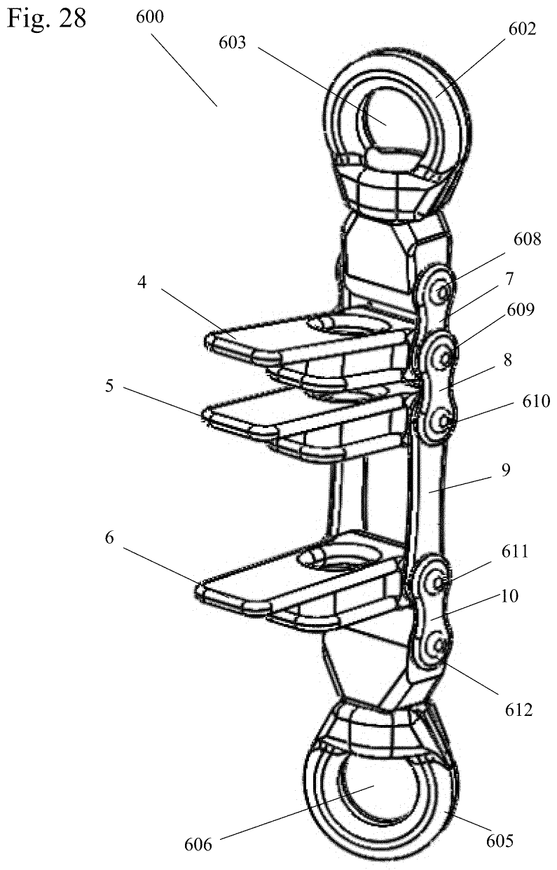

### FIG. 28

The tower positioner 600 has a bendable body which is formed by a series of links. In this embodiment, the top attach link 72 and the bottom attach link 71 are replaced with a top attach swivel 602 and a bottom attach swivel 605. The top attach swivel 602 includes a top attach point 603. The bottom attach swivel 605 includes a bottom attach point 606. The top attach swivel 602 and bottom attach swivel 605 are pivotable about a vertical axis of the tower positioner 600 and can preferably rotate 360 degrees about the axis.

In order from top to bottom, the tower positioner 600 includes a top attach swivel 602 with a top attach point 603, a first link 7, a second link 8, a third link 9, a fourth link 10 and a bottom attach swivel 605 with a bottom attach point 606. The links 602, 7, 8, 9, 10, 605 are connected by axles or pins 608, 609, 610, 611, 612 so that adjoining links can bend or pivot relative to each other.

The axle or pin 608 connects the first link 7 to the top attach swivel 602. The axle or pin 609 connects the first link 7 and the second link 8 and forms the axle for the upper control plate 4. Axle or pin 610 connects the second link 8 to the third rigid link 9 and is the axle for the middle control plate 5. Axle or pin 611 connects the third rigid link 9 and the fourth link 10 to the lower control plate 6 and axle or pin 612 connects the bottom attach swivel 605 to the fourth link 10. The bottom and top attachment swivels 602, 605 allow the tower positioner 600 to rotate as needed during use by the climber.

### Tower Positioner with Perpendicular Attachment Points

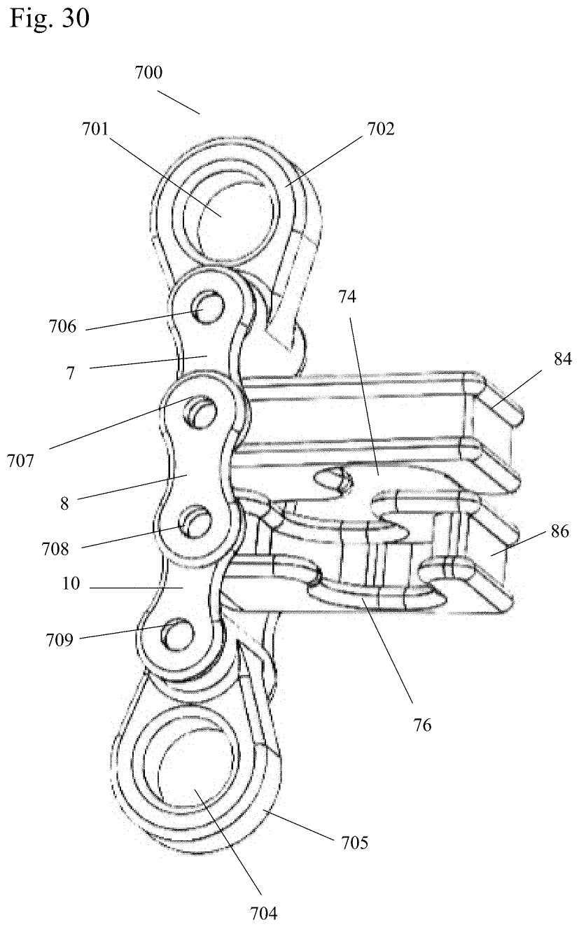

### FIG. 30

The tower positioner 700 of this embodiment has a bendable body which is formed by a series of links. In this embodiment, the top attach link 72 and bottom attach link 71 are replaced with a top attach link 702 and bottom attach link 705. The top attach link 702 is attached to a first link 7 and the bottom attach link 701 is attached to a fourth link 10. The top attach link 702 has a top attach point 701 and the bottom attach link 705 has a bottom attach point 704. The top attach point 701 and the bottom attach point 704 are perpendicular to movement of the clutch plates 84, 86.

In order from top to bottom, the tower positioner 700 includes a top attach link 702 with a top attach point 701, a first link 7, a second link 8, a fourth link 10 and a bottom attach link 705 with a bottom attach point 704. The links 702, 7, 8, 10, 705 are connected by axles or pins 706, 707, 708, 709 so that adjoining links can bend or pivot relative to each other.

The axle or pin 706 connects the first link 7 to the top attach point 702. The axle or pin 707 connects the first link 7 and the second link 8 and forms the axle for the upper control plate 84. Axle or pin 708 connects the second link 8 to the third link 9 and is the axle for the lower control plate 86. Axle or pin 709 connects the bottom attach link 705 to the fourth link 10.

### Spring Loaded Control Plates

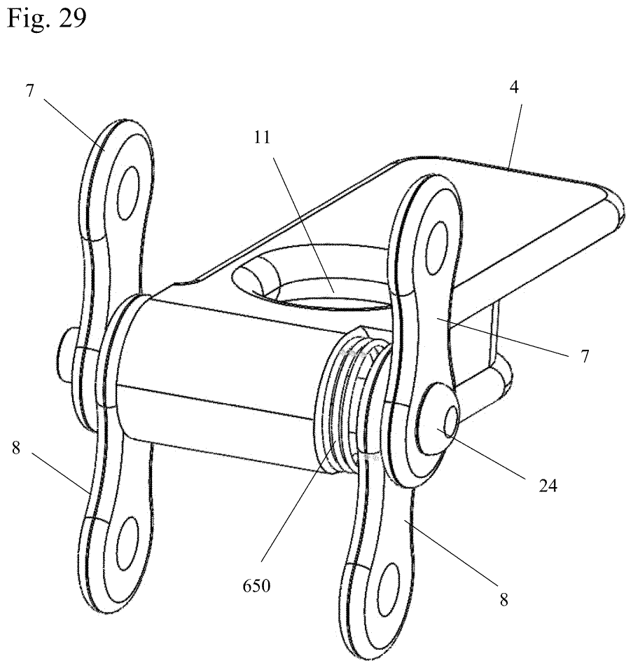

### FIG. 29

FIG. 29 shows a spring loaded control plate in which the control plate 4 is biased to a closed or upward position by a spring 650. The spring 650 may be a coil spring or a watch spring. The spring loading of the control plates can be added to any of the control plates in the above embodiments.

### Usage of the Tower Positioner Device

As a rope grab, the tower positioner device 20, 40, 60, 200, 300, 400, 500, 600, 700 can be used on a lanyard, rope or flip line to adjust the lanyard or rope length. With a fairlead pulley, the lanyard or rope 3 can be shortened with one hand by pulling the tail exiting the tower position device 20, 40, 60, 200, 300, 400, 500, 600, 700 up toward the working end the pulley advances the tower positioner device 20, 40, 60, 200, 300, 400, 500, 600, 700 up the line. To lengthen the lanyard or rope, the top handle of a control plate 4, 84, is depressed and rope 3 can be let through the tower positioner device 20, 40, 60, 200, 300, 400, 500, 600, 700. Both operations can be done with one hand.

As a foot ascender, the lower attachment point 1, 71, 605, 705 of the tower positioner device 20, 40, 60, 200, 300, 400, 500, 600, 700 is attached to a foot loop, and a bungee cord is attached to the top attachment point 2, 72, 602, 702. The top attachment point 2, 72, 602, 702 can be attached to a waist harness, or alternatively attached to the climber's pant leg with a clip.

As a knee ascender, the tower positioner device 20, 40, 60, 200, 300, 400, 500, 600, 700 is positioned at around the knee level with a foot loop and lanyard of the correct length and a bungee cord supporting the tower positioner device 20, 40, 60, 200, 300, 400, 500, 600, 700 from the top.

### Single Rope Technique

In use with a single rope 3, the tower positioner device 20, 40, 60, 200, 300, 400, 500, 600, 700 is attached to the climber's harness with a carabineer 350, 352 or the like, at the bottom attachment point 1, 71, 605, 705, and a chest harness is attached to the top attachment point 2, 72, 603, 702, with a single rope 3 attached to a high anchor point, and the rope's free end threaded through the tower positioner device 20, 40, 60, 200, 300, 400, 500, 600, 700, the climber can with the help of a foot ascender or the like, can ascend the rope 3 by steeping up on the foot ascender and there by advancing the tower positioner device 20, 40, 60, 200, 300, 400, 500, 600, 700 up the rope 3, then transferring weight to the tower positioner device 20, 40, 60, 200, 300, 400, 500, 600, 700 by sitting back into the harness and advancing the foot ascender up the rope 3 and repeat. In this sit stand method the climber effectively inchworms themselves up the rope 3.

### Doubled Rope Technique

In a dynamic doubled rope system, shown in FIG. 13, the rope 3 is attached to the top attachment point 82 of the device 40, possibly using a knot 92, then goes up and over a secure anchor point 33, or through a pulley, and back down though the plates 4, 5, 6 of the device 40. The lower attachment point 81 is attached to a harness with a carabineer or the like.

By simply pulling the rope 3 exiting the bottom of the tower positioner device 40, the tower positioner device 40 advances up the rope 3 automatically as it is being pulled by the end of the rope 3. This has the advantage of being a two-to-one system, so as a climber you only have to lift half your weight to ascend.

### Two Line System

In a two line system, as used in most rope access work, one rope is a “safety” or “rescue” rope for emergency fall arrest, and the other is the working rope for work positioning. Two tower positioner devices 20, 40, 60, 200, 300, 400, 500, 600, 700 can be used, one for work positioning and one for fall arrest and self-recue, in this system there is always a back up system in case one fails. In practice, the climber ascends on one rope and the other tower positioner device 20, 40, 60, 200, 300, 400, 500, 600, 700 follows up on the other, capturing any progress made, if a fall occurs, the tower positioner device 20, 40, 60, 200, 300, 400, 500, 600, 700 catches the climber's fall, and limits the damaging dynamic forces on the climber's body, by decelerating the climber's weight, without damaging the rope, and leaves open the option to safely descend the rope to the ground (self-rescue).

Accordingly, it is to be understood that the embodiments of the invention herein described are merely illustrative of the application of the principles of the invention. Reference herein to details of the illustrated embodiments is not intended to limit the scope of the claims to be filed in a utility patent application claiming benefit of this provisional application, which themselves will recite those features regarded as essential to the invention.

What is claimed is:

1. A tower positioner device for use with at least one rope comprising:
a body with a top attachment point and a lower attachment point;
a top control plate pivotably connected to the body adjacent the top attachment point;
a lower control plate pivotably connected to the body adjacent the bottom attachment point;
at least one middle control plate pivotably connected to the body between the top control plate and the lower control plate;
each of the top control plate, the lower control plate, and the at least one middle control plate including:
a first upper oblong hole;
a second lower oblong hole offset from the first upper oblong hole and separated by a gap;
an axle hole for receiving an axle to connect to the body along an axis of a short side of the first upper oblong hole and the second lower oblong hole;
a handle opposite the axle hole;
wherein the offset between the first upper oblong hole and the second lower oblong hole is perpendicular to the axle hole;
wherein the top control plate, the lower control plate and the at least one middle control plate are pivotable between an upward position and a downward position,
such that when the top control plate, the lower control plate, and the least one middle control plate are moved to the downward position, a rope path through the first upper oblong hole and the second lower oblong hole is open and the rope can pass through the first upper oblong hole and the second lower oblong hole of each of the top control plate, the lower control plate and the at least one middle control plate without resistance;
such that when the top control plate, the lower control plate, and the least one middle control plate are moved to the upward position, the rope path through the first upper oblong hole and the second lower oblong hole is restricted, forcing the rope to bend to an S-shape, generating friction between a point on the first upper oblong hole and the second lower oblong hole; and
wherein the top control plate and the at least one middle control plate when in the upward position acts a plane clamp on the rope and the bottom control plate acts as brake on the rope.

2. The tower positioner device of claim 1, the body is a unitary body.

3. The tower positioner device of claim 2, wherein the unitary body further comprises a roller arm having a rotatable roller.

4. The tower positioner device of claim 1, wherein the body is bendable and comprises:
a first link pivotably connected to the top attachment point and the upper control plate;
a second link pivotably connected to the first link, the upper control plate, and the at least one middle control plate;
a third link pivotably connected to the second link, the at least one middle control plate, and the lower control plate;
a fourth link pivotably connected to the lower control plate and the bottom attachment point.

5. The tower positioner device of claim 4, wherein the third link is rigid.

6. The tower positioner device of claim 1, wherein the top attachment point and the bottom attachment point can rotate 360 degrees relative to the upper control plate.

7. The tower positioner device of claim 1, wherein the bottom attachment point and the top attachment point are perpendicular to the axle hole of the upper control plate, the lower control plate and the at least one middle control plate.

8. The tower positioner device of claim 1, wherein the body is bendable and comprises:
a first link pivotably connected to the top attachment point and the upper control plate;
a second link pivotably connected to the first link, the upper control plate, and a first of the at least one middle control plate;
another second link pivotably connected to the first of the at least one middle control plates and a second of the at least one middle control plates;
a third link pivotably connected to the another second link, the second of the at least one middle control plate, and the lower control plate;
a fourth link pivotably connected to the lower control plate and the bottom attachment point.

9. The tower positioner device of claim 1, further comprising a shroud surrounding the tower positioner device, the shroud comprising a body having a first side, a second side opposite the first side, a U-shaped slot in the first side and the second side, a front side and a back side, wherein the back side has a first attachment point and a second attachment point and the first attachment point is aligned with the top attachment point of the tower positioner device and the second attachment point is aligned with the bottom attachment point.

10. The tower positioner device of claim 1, wherein at least one of the upper control plate, the at least one middle control plate and the lower control plate are spring loaded towards the upward position.

11. A tower positioner device for use with at least one rope comprising:
a body with a top attachment point and a lower attachment point;
a top control plate pivotably connected to the body adjacent the top attachment point including a first top sub plate with a first side oblong opening hole and a second top sub plate with a second side oblong opening hole offset from the first side oblong opening hole on a same side of the top control plate, the first top sub plate and the second top sub plate having a handle at one end and an axle hole an opposite end;
a lower control plate pivotably connected to the body adjacent the bottom attachment point including a first lower sub plate with a first side oblong opening hole and a second lower sub plate with a second side oblong opening hole offset from the first side oblong opening hole on a same side of the lower control plate, the first lower sub plate and the second lower sub plate having a handle at one end and an axle hole at an opposite end;
a middle control plate pivotably connected to the body between the top control plate and the lower control plate including a first middle sub plate with a first side oblong opening hole and a second middle sub plate with a second side oblong opening hole offset from the first side oblong opening hole on a same side of the middle control plate, the first middle sub plate and second middle sub plate having a handle at one end and an axle hole at an opposite end;
wherein the first side oblong opening and the second side oblong opening of the top control plate and the lower control plate are aligned on a same side and the first side oblong opening and the second side oblong opening of the middle control plate are on an opposite side, such that the rope can be threaded into the top control plate, middle control plate and lower control plate midline;
wherein the top control plate, the lower control plate and the at least one middle control plate are pivotable between an upward position and a downward position,
such that when the top control plate, the lower control plate, and the least one middle control plate are moved to the downward position, a rope path through the first side oblong opening and the second side oblong opening is open and the rope can pass through the first side oblong opening and the second side oblong opening of each of the top control plate, the lower control plate and the middle control plate without resistance;
such that when the top control plate, the lower control plate, and the middle control plate are moved to the upward position, the rope path through the first side oblong opening and the second side oblong opening is restricted, forcing the rope to bend to an S-shape, generating friction between a point on the first side oblong opening and the second side oblong opening; and
wherein the top control plate and the middle control plate when in the upward position acts a plane clamp on the rope and the bottom control plate acts as brake on the rope.

12. The tower positioner device of claim 11, further comprising a lock plate for each of the top control plate, lower control plate and the middle control plate pivotably attached to the body.

13. The tower positioner device of claim 12, wherein the lock plate for the lower control plate further comprises a rotatable roller.

14. The tower positioner device of claim 11, wherein the body is bendable and comprises:
a first link pivotably connected to the top attachment point and the upper control point;
a second link pivotably connected to the first link, the upper control plate, and the middle control plate;
a third link pivotably connected to the second link, the middle control plate, and the lower control plate;
a fourth link pivotably connected to the lower control plate and the bottom attachment point.

15. The tower positioner device of claim 14, wherein the third link is rigid.

16. The tower positioner device of claim 11, wherein the top attachment point and the bottom attachment point can rotate 360 degrees relative to the upper control plate.

17. The tower positioner device of claim 11, wherein the bottom attachment point and the top attachment point are perpendicular to the axle hole of the upper control plate, the lower control plate and the at least one middle control plate.

18. The tower positioner device of claim 11, wherein at least one of the upper control plate, the middle control plate and the lower control plate are spring loaded towards the upward position.

19. A tower positioner device for use with at least one rope comprising:
a body with a top attachment point and a lower attachment point;
a top control plate pivotably connected to the body adjacent the top attachment point including a first top sub plate with a first side oblong opening hole and a second top sub plate with a second side oblong opening hole offset from the first side oblong opening hole on a same side of the top control plate, the first top sub plate and the second top sub plate having a handle at one end and an axle hole an opposite end;
a lower control plate pivotably connected to the body adjacent the bottom attachment point including a first lower sub plate with a first side oblong opening hole and a second lower sub plate with a second side oblong opening hole offset from the first side oblong opening hole on a same side of the lower control plate, the first lower sub plate and the second lower sub plate having a handle at one end and an axle hole at an opposite end;
wherein the first side oblong opening and the second side oblong opening of the top control plate and the lower control plate are aligned on an opposite side, such that the rope can be threaded into the top control plate and the lower control plate midline;
wherein the top control plate and the lower control plate are pivotable between an upward position and a downward position,
such that when the top control plate and the lower control plate are moved to the downward position, a rope path through the first side oblong opening and the second side oblong opening is open and the rope can pass through the first side oblong opening and the second side oblong opening of each of the top control plate and the lower control plate without resistance;
such that when the top control plate and the lower control plate are moved to the upward position, the rope path through the first side oblong opening and the second side oblong opening is restricted, forcing the rope to bend to an S-shape, generating friction between a point on the first side oblong opening and the second side oblong opening; and
wherein when the top control plate is in the upward position acts a plane clamp on the rope and the lower control plate acts as brake on the rope.

20. The tower positioner device of claim 19, wherein the body is bendable and comprises:
a first link pivotably connected to the top attachment point and the upper control point;
a second link pivotably connected to the first link, the upper control plate, and the lower control plate;
a fourth link pivotably connected to the lower control plate and the bottom attachment point.
